(19) United States
(12) Patent Application Publication
(10) Pub. No.: US 2026/0259905 A1
(43) Pub. Date: Sep. 3, 2026

(54) Large Language Model Augmented User Emergency Interface

(71) Applicant: Google LLC, Mountain View, CA (US)

(72) Inventors: Aishwarya Mallampati, Gilroy, CA (US); Sooraj Sasindran, San Diego, CA (US)

(73) Assignee: Google LLC, Mountain View, CA (US)

(21) Appl. No.: 19/656,292

(22) Filed: Apr. 23, 2026

(51) Int. Cl. G06F 16/3329; H04W 4/90

(52) U.S. Cl. CPC G06F 16/33295; H04W 4/90

(57) ABSTRACT

This document describes systems and techniques directed at a large language model (LLM) augmented user emergency interface. A user device receives, via a user emergency interface, a free-form input associated with an emergency event. An LLM, at least partially deployed on the user device, extracts one or more relevant details of the emergency event from the free-form input. The free-form input can be a text input, a voice input, or a natural language input. The LLM generates an emergency message based on the one or more relevant details. The user device provides, for an emergency messaging session, the emergency message. The LLM can further be configured to compress the emergency message prior to the providing of the emergency message over a bandwidth-constrained network or a latency-constrained network, such as a satellite communication network.

### SUMMARY

This document describes systems and techniques directed at a large language model (LLM) augmented user emergency interface. A user device receives, via a user emergency interface, a free-form input associated with an emergency event. An LLM, at least partially deployed on the user device, extracts one or more relevant details of the emergency event from the free-form input. The free-form input can be a text input, a voice input, or a natural language input. The LLM generates an emergency message based on the one or more relevant details. The user device provides, for an emergency messaging session, the emergency message. The LLM can further be configured to compress the emergency message prior to the providing of the emergency message over a bandwidth-constrained network or a latency-constrained network, such as a satellite communication network.

In aspects, a method is disclosed that includes receiving, via a user emergency interface, a free-form input associated with an emergency event. The method further includes extracting, with an LLM, one or more relevant details of the emergency event from the free-form input. The method further includes generating, by the LLM, an emergency message based on the one or more relevant details. The method further includes providing, for an emergency messaging session, the emergency message.

This Summary is provided to introduce simplified concepts of a large language model augmented user emergency interface, which are further described below in the Detailed Description and are illustrated in the Drawings. This Summary is intended neither to identify essential features of the claimed subject matter nor for use in determining the scope of the claimed subject matter.

### BRIEF DESCRIPTION OF THE DRAWINGS

The details of one or more aspects of systems and techniques for a large language model augmented user emergency interface are described in this document with reference to the following drawings:

FIG. 1 illustrates an example environment in which techniques for a large language model augmented user emergency interface may be implemented;

FIG. 2 illustrates an example of an electronic device of FIG. 1 for implementing a large language model augmented user emergency interface;

FIG. 3 illustrates an example environment in which techniques for a large language model augmented user emergency interface may be implemented;

FIG. 4 illustrates an example trainer for an LLM, such as one used in a large language model augmented user emergency interface; and

FIG. 5 illustrates an example method for implementing a large language model augmented user emergency interface.

The use of same numbers in different instances may indicate similar features or components.

### DETAILED DESCRIPTION

### Overview

The promulgation of mobile communications with satellite connectivity has significantly enhanced personal safety, allowing individuals to reach emergency services from remote locations. Traditionally, emergency messaging over bandwidth-constrained networks, such as satellite networks, relies on structured, questionnaire-based interfaces. A user in distress is required to complete a multi-step form before transmission is allowed. However, this methodology introduces significant pre-transmission delays and imposes a high cognitive load on the user during a crisis. The frustration of manually selecting categories and filling structured fields while injured or panicked can lead to poor data quality or a failure to send the message at all. Furthermore, structured questionnaires often transmit superfluous metadata and empty fields, resulting in a larger single data payload than necessary. This increased payload size can prove prohibitive over latency-constrained or bandwidth-constrained connections.

Relegating robust natural language processing to server-side applications denies users the ability to leverage intelligent data extraction from the increased utility and functionality of artificial intelligence (AI), particularly large language models (LLMs), in off-grid emergencies. For example, relying on a cloud-based LLM to parse an emergency message is impossible if a user's smartphone is not connected to a terrestrial network. Even when connected, the back-and-forth communication required to clarify details with emergency services can result in a poor user experience and critical delays. In instances where satellite communication imposes a latency of several seconds per message transmission, the act of sending and receiving multiple manual questions may result in a costly delay before sufficient help can be dispatched.

This document describes systems and techniques directed at a large language model augmented user emergency interface. A user device receives, via a user emergency interface, a free-form input associated with an emergency event. An LLM, at least partially deployed on the user device, extracts one or more relevant details of the emergency event from the free-form input. The free-form input can be a text input, a voice input, or a natural language input. The LLM generates an emergency message based on the one or more relevant details. The user device provides, for an emergency messaging session, the emergency message. The LLM can further be configured to compress the emergency message prior to the providing of the emergency message over a bandwidth-constrained network or a latency-constrained network, such as a satellite communication network.

According to some examples, by utilizing a lightweight, on-device LLM to instantly process detailed, free-form emergency inputs, the system can condense critical facts without reliance on intermittent cloud connectivity. Advantages of employing the LLM locally include lower transmission payload sizes, drastically reduced initial triage time, and the ability to deploy an intelligent extraction model on resource-constrained devices, such as a smartphone, to acquire high-fidelity actionable data in off-grid scenarios.

In aspects, one or more processors can receive a free-form input associated with an emergency event via a user emergency interface on a user device. A large language model can extract one or more relevant details of the emergency event from the free-form input. The large language model can generate an emergency message based on the one or more relevant details, and the emergency message can be provided for an emergency messaging session. The free-form input can include a text input or a voice input, and the free-form input can also include a natural language input.

The large language model can be a lightweight large language model configured to execute locally on the user device. The large language model can be instantiated on the user device, the extracting of the one or more relevant details can be performed on the user device, and the generating of the emergency message can be performed on the user device. The emergency message can have a reduced footprint from the free-form input, where the footprint includes a measure of used compute resources. The compute resources can include one or more of a memory usage, a processor cycle usage, and a network usage.

The one or more relevant details can include a location associated with the emergency event, an injury status, a psychological state, an equipment loss, a number of individuals associated with the emergency event, or a resource requirement. Where the one or more relevant details include a location associated with the emergency event, the location associated with the emergency event can be determined using one or more device parameters of a user device. The one or more device parameters can include one or more of a Global Positioning System (GPS) output, a cellular network connection status of the user device, and a Wi-Fi connection status of the user device. Where the one or more device parameters include the GPS output, the GPS output can be generated by one or more GPS sensors of the user device.

The generating of the emergency message can include formatting the one or more relevant details into an all-caps format using a standardized syntax. The large language model can generate a dynamic questionnaire tailored to a specific situation of the emergency event. The dynamic questionnaire can be provided via the user emergency interface. A response to the dynamic questionnaire can be received, and one or more additional relevant details can be extracted from the response. The generating of the emergency message can be further based on the one or more additional relevant details.

The emergency messaging session can utilize a satellite communication network. The emergency message can be compressed prior to the providing of the emergency message over the satellite communication network. The compressing of the emergency message can include converting the one or more relevant details into one or more binary encodings corresponding to one or more predefined identifiers recognizable by an emergency rescue center.

### Operating Environment

The following discussion describes operating environments, techniques that may be employed in the operating environments, and various devices or systems in which components of the operating environments can be embodied. In the context of the present disclosure, reference is made to the operating environments by way of example only.

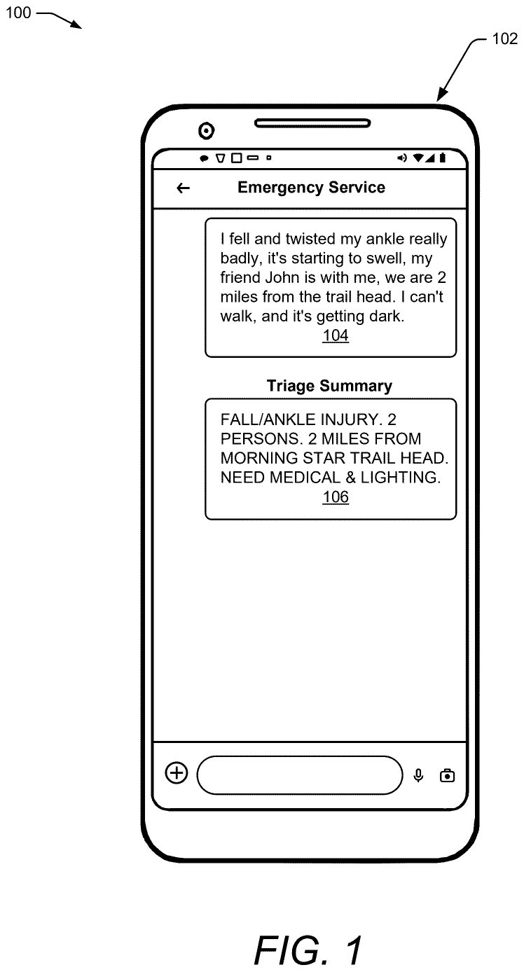

FIG. 1 illustrates an example environment 100 in which techniques for a large language model augmented user emergency interface can be implemented. Generally, the environment 100 includes an electronic device 102. The electronic device 102 in the example pictured is a smartphone, though it should be noted that other electronic devices can be used equivalently. The electronic device 102 includes an instantiated LLM (not pictured). An input can be given to the LLM, such as a free-form input 104. The free-form input 104 is illustrated in FIG. 1 as a user text input describing an emergency event but may be the product of a machine or machine algorithm. The free-form input 104 is illustrated as a text input, but other input types may be used (e.g., a voice input, an audio recording, a text input, or another form of natural language input). The LLM, in aspects, can provide an emergency message 106, which can include a triage summary of extracted relevant details.

The electronic device 102, in some examples, can be an assistant device (e.g., Google® Nest® Hub; Google® Nest® Hub Max), a home automation controller (e.g., controller for an alarm system, thermostat, lighting system, door lock, motorized doors, etc.), a gaming device (e.g., a gaming system, gaming controller, data glove, etc.), a communication device (e.g., a smart phone such as a Google® Pixel® Phone, cellular phone, mobile phone, wireless phone, portable phone, radio telephone, etc.), a wearable device (e.g., smart watch, smart glasses, earbuds, smart helmet, VR headset, AR goggles, smart ring, etc.), a vehicle (car, electric scooter, automated vehicle, etc.), and/or another computing device (e.g., a tablet computer, phablet computer, notebook computer, laptop computer, etc.). As another example, the electronic device 102 with an assistant application or program (e.g., the AI assistant) may audibly convey information to a user.

In some examples, the emergency message 106 is based on data extracted from the free-form input 104. According to some examples, the emergency message 106 is based on one or more capabilities or device parameters of the electronic device 102, such as a global positioning system (GPS) output or a network connection status. In some examples, the emergency message 106 is based on data stored remotely from the electronic device 102 (e.g., historical emergency communications or structured communication formats from emergency service providers accessed via a wireless communications link). In some examples, the emergency message 106 is produced using only resources of the electronic device 102 (e.g., an on-device lightweight LLM utilizing one or more processors of the electronic device 102, the memory of the electronic device 102, etc.), resources of a remote device, or both.

### Example Devices

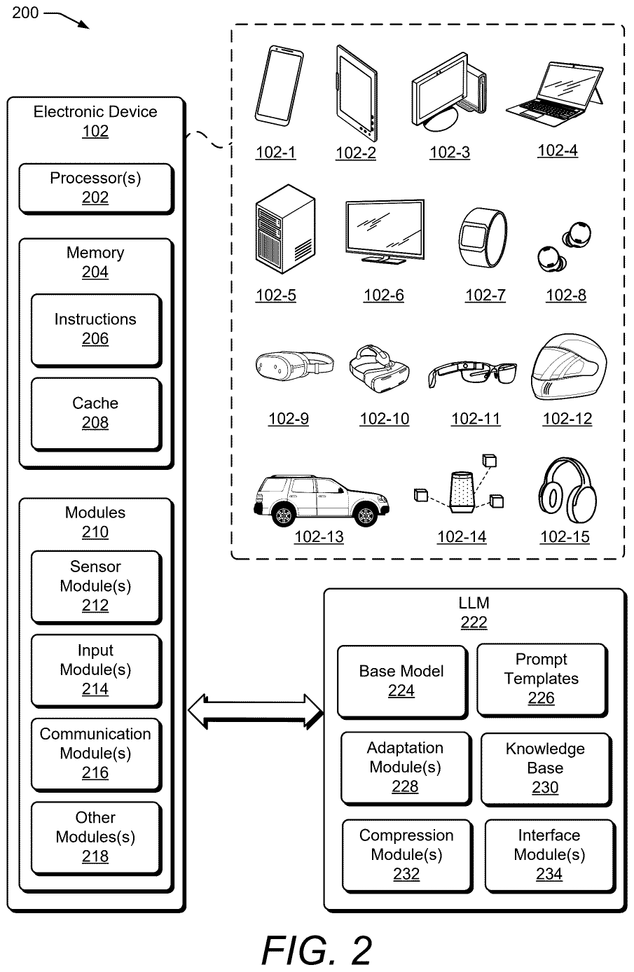

FIG. 2 illustrates an example of an electronic device 102 of FIG. 1 for implementing an LLM augmented user emergency interface. Examples of the electronic device 102 include a smartphone 102-1, a tablet device 102-2, a desktop computer 102-3, a laptop computer 102-4, a server 102-5 (including a server array), a smart monitor or TV 102-6, a smartwatch 102-7, earbuds (e.g., true-wireless earbuds) 102-8, VR goggles 102-9, an AR headset 102-10, smart-glasses 102-11, a smart-helmet 102-12, a smart vehicle 102-13, a home hub device 102-14, and headphones 102-15. Although not shown, the electronic device 102 may also be implemented as any of a mobile communication device, a client device, a home automation and control system, an entertainment system, a personal media device, a health measurement device, a drone, a camera, an Internet home appliance capable of wireless Internet access and browsing, an IoT device, security systems, and the like. Note that the electronic device 102 can be wearable, non-wearable but mobile, or relatively immobile (e.g., appliances). The electronic device 102 may include components or interfaces omitted from FIG. 2 for the sake of clarity or visual brevity.

As illustrated, the electronic device 102 includes one or more processors 202 and a memory 204 (e.g., a computer-readable medium). The one or more processors 202 may include any suitable single-core or multi-core processor (an application processor (AP), a digital-signal processor (DSP), a central processing unit (CPU), a graphics processing unit (GPU), a tensor processing unit (TPU), etc.). The one or more processors 202 may be configured to execute instructions or commands stored within the memory 204. The memory 204 may be stored within one or more non-transitory storage devices (e.g., a random access memory (RAM), dynamic RAM (DRAM), non-volatile RAM (NVRAM), static RAM (SRAM), etc.), a read-only memory (ROM), a flash memory, a hard drive, a solid-state drive (SSD), or any type of media suitable for storing electronic instructions), each coupled with a computer system bus. The term “coupled” may refer to two or more elements that are in direct contact (physically, electrically, magnetically, optically, etc.) or to two or more elements that are not in direct contact with each other but still cooperate and/or interact with each other. The memory 204 may, for instance, store one or more predefined identifiers, standardized syntax rules, or binary encodings for condensing emergency messages.

The memory 204, in some examples, includes instructions 206. The instructions 206 can be in the form of executable code, one or more applications, software, etc. In some examples, the memory 204 further includes a cache 208. According to some examples, the cache 208 is a virtual memory partition of the memory 204. In some examples, the cache 208 is a physical partition of the memory 204.

The electronic device 102 includes, in some examples, one or more modules 210. One or more capabilities of the electronic device 102 can be based on the one or more modules 210. Examples of the one or more modules 210 include one or more sensor modules 212, one or more input modules 214, one or more communication modules 216, and one or more other modules 218. The one or more sensor modules 212 may include GPS sensors, biometric sensors, capacitive sensors, infrared sensors, optical sensors, etc. Data based on any one of the one or more sensor modules 212 may be used in extracting relevant details from an input (e.g., the free-form input 104 of FIG. 1), as a basis for generating an output (e.g., the emergency message 106 of FIG. 1), as a derived location associated with the emergency event, or as any other aspect of the LLM augmented user emergency interface. Similarly, data based on any one of the one or more input modules 214 (e.g., a microphone or touchscreen interface) may be used in receiving the input (e.g., the free-form input 104 of FIG. 1), as a basis for the generated output (e.g., the emergency message 106 of FIG. 1), as a response to a dynamic questionnaire, or as any other aspect of the LLM augmented user emergency interface.

The one or more communication modules 216 may include wired or wireless connection interfaces, radios, connection protocols, etc. The one or more other modules 218 may include other aspects of the electronic device 102 not shown for clarity (e.g., a screen, a microphone, or other capabilities of the electronic device 102). The one or more communication modules 216, the one or more other modules 218, or both may also be used in capturing an input (e.g., the free-form input 104 of FIG. 1), as a basis for a generated output (e.g., the emergency message 106 of FIG. 1), as an action for transmitting the output over an emergency messaging session, or as any other aspect of the large language model augmented user emergency interface. The one or more communication modules 216 may enable communication of device data (e.g., received data, transmitted data, or other information as described herein) and may provide connectivity to one or more networks and other devices connected therewith. Examples of the one or more communication modules 216 include near field communications (NFC) transceivers, wireless personal area network (WPAN) radios compliant with various IEEE 802.15 (Bluetooth®) standards, wireless local area network (WLAN) radios compliant with any of various IEEE 802.11 (WiFi®) standards, wireless wide area network (WWAN) (3GPP-compliant) radios for cellular telephony, wireless metropolitan area network (WMAN) radios compliant with various IEEE 802.16 (WiMAX®) standards, infrared (IR) transceivers compliant with an Infrared Data Association (IrDA) protocol, and wired local area network (LAN) Ethernet transceivers. Examples of the one or more communication modules 216 may also include satellite communication transceivers tailored for bandwidth-constrained or latency-constrained networks. Device data communicated over the one or more communication modules 216 may be packetized or framed depending on a communication protocol or standard by which the electronic device 102 is communicating. The one or more communication modules 216 may include interfaces for communication over a local network, a private network, an intranet, the Internet, or wireless networks (e.g., WLANs, cellular networks, or WPANs).

The electronic device 102 may further include and/or be operatively coupled to an LLM 222. For example, the LLM 222 may be stored on the memory 204 (e.g., as part of the instructions 206). In another example, the LLM 222 is stored remote from the electronic device 102 and is accessed via the one or more communication modules 216. The LLM 222 includes one or more of a base model 224, prompt templates 226, one or more adaptation modules 228, a knowledge base 230, one or more compression modules 232, and one or more interface modules 234.

The LLM 222, in aspects, utilizes the base model 224 and the one or more adaptation modules 228 to efficiently extract emergency facts without overburdening the device. The base model 224 may include an off-the-shelf lightweight model configured to execute locally on the electronic device 102. In some examples, the base model 224 includes a plurality of frozen parameters that are configured to be maintained in a frozen state during training operations. The one or more adaptation modules 228 may include a plurality of trainable parameters configured to fine-tune the LLM 222 for specific emergency event extraction tasks without fundamentally altering the frozen parameters of the base model 224. This architecture can allow the LLM 222 to maintain a small footprint suitable for on-device deployment while ensuring the high-fidelity extraction of relevant details required for an emergency response.

The LLM 222 may further rely on the prompt templates 226 and the knowledge base 230 to guide the formatting and generation of the emergency message. The prompt templates 226 may include predefined prompt templates that provide one or more structural constraints for the emergency message, such as forcing a standardized syntax or an all-caps format (e.g., the emergency message 106 of FIG. 1). In some examples, the prompt templates 226 include one or more examples mapping sample free-form inputs to standardized emergency outputs, enabling the LLM 222 to accurately condense unstructured communications. Additionally, the knowledge base 230 may be queried based at least in part on the free-form input to retrieve contextual reference data. The electronic device 102 may then augment the free-form input with the contextual reference data prior to extracting the one or more relevant details, thereby improving the contextual awareness and accuracy of the resulting triage summary.

In some examples, the LLM 222 employs the one or more compression modules 232 to optimize the emergency message prior to transmission over a bandwidth-constrained network or a latency-constrained network, such as a satellite communication network. The one or more compression modules 232 may radically reduce the payload size by converting the extracted relevant details into one or more binary encodings prior to providing the emergency message. For example, these binary encodings can correspond to one or more predefined identifiers uniquely recognized by an emergency rescue center (e.g., specific codes for phrases like “car accident” or “hypothermia”). By consolidating the relevant details into a single, minimal transmission payload, the one or more compression modules 232 mitigate data overhead, limit pre-transmission delays, and increase communication resilience over satellite or degraded terrestrial networks.

The one or more interface modules 234, in aspects, provide for interfacing between the LLM 222 and other devices, bots, etc. For example, the LLM 222 can use the one or more interface modules 234 to connect with a different LLM or an emergency dispatch server that is deployed on a remote device. For example, the different LLM can have access to restricted data that the LLM 222 cannot access itself. In another example, the one or more interface modules 234 can import sensor data from the one or more sensor modules 212 of the electronic device 102. For example, the LLM 222 can, using the one or more interface modules 234, obtain a user facial expression for use as at least part of the input, the user facial expression based on camera data from a camera of the one or more input modules 214. In further examples, the one or more interface modules 234 can interface directly with a native operating system communication interface, such as a 911 messaging stack or satellite SOS framework.

### Example Information Request

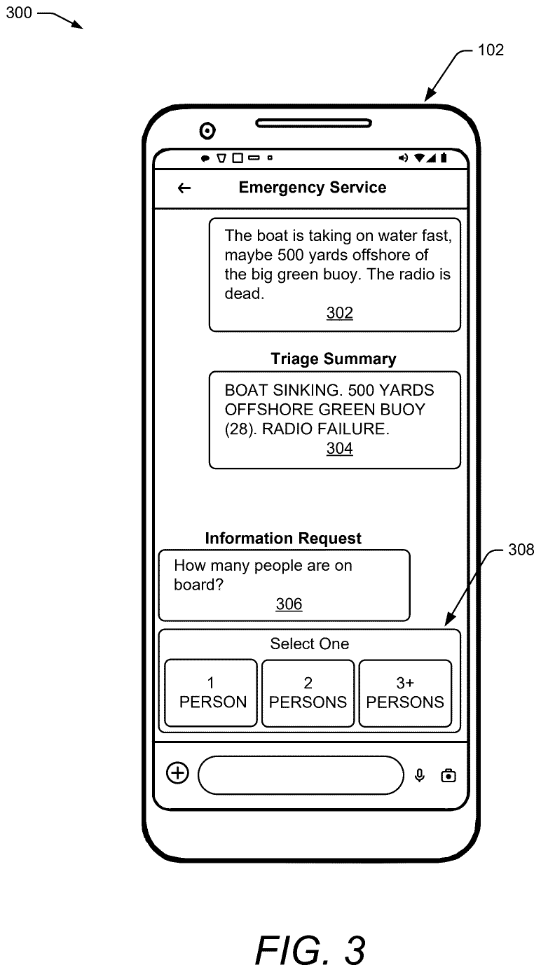

FIG. 3 illustrates an example environment 300 in which aspects of an LLM augmented user emergency interface can be implemented. The environment 300 includes the electronic device 102, which is illustrated as a smartphone but may be any suitable user device. The electronic device 102 displays a user emergency interface configured to receive a free-form input 302 (e.g., the free-form input 104 of FIG. 1) describing an emergency event. As shown, the free-form input 302 includes the text: “The boat is taking on water fast, maybe 500 yards offshore of the big green buoy. The radio is dead.”

Based on the free-form input 302, an instantiated large language model (e.g., the LLM 222 of FIG. 2) extracts one or more relevant details to generate an emergency message 304 (e.g., the emergency message 106 of FIG. 1). The emergency message 304 is displayed as a triage summary that concisely formats the extracted facts into a standardized syntax: “BOAT SINKING. 500 YARDS OFFSHORE GREEN BUOY (28). RADIO FAILURE.” To gather further critical information without relying on static, mandatory forms, the LLM can dynamically generate a dynamic questionnaire 306 tailored to the specific situation of the emergency event. In the illustrated example, the dynamic questionnaire 306 asks, “How many people are on board?” and provides an interface with at least one click-based selection 308 (e.g., “1 PERSON”, “2 PERSONS”, “3+ PERSONS”). By dynamically prompting the user for missing facts, the electronic device 102 may avoid unnecessary and/or time-consuming back-and-forth communication with remote emergency services. Upon receiving a response to the dynamic questionnaire 306, the LLM can extract additional relevant details and consolidate them into the emergency message 304 for a single, efficient transmission payload.

### Large Language Models (LLMs)

Generally, LLMs are a class of artificial intelligence (AI). LLMs (e.g., the LLM 222 of FIG. 2) are trained on enormous amounts of data to provide foundational capabilities, which can be used and reused, often through fine-tuning for particular applications and tasks. Other software applications, in contrast, are often built and trained on specific data for each use case. In this way, LLMs are considered a type of foundational model.

Some LLMs use a machine-learned (ML) computer model that can parse language and provide context-aware outputs, for example to mimic a human response. This mimic of a human response is typically to a prompt, for example from a user asking a question. The prompt “ask how to get to the train station in French,” for example, can be used as a prompt by which an LLM provides a translation service, namely a human response in the French language to the English language prompt.

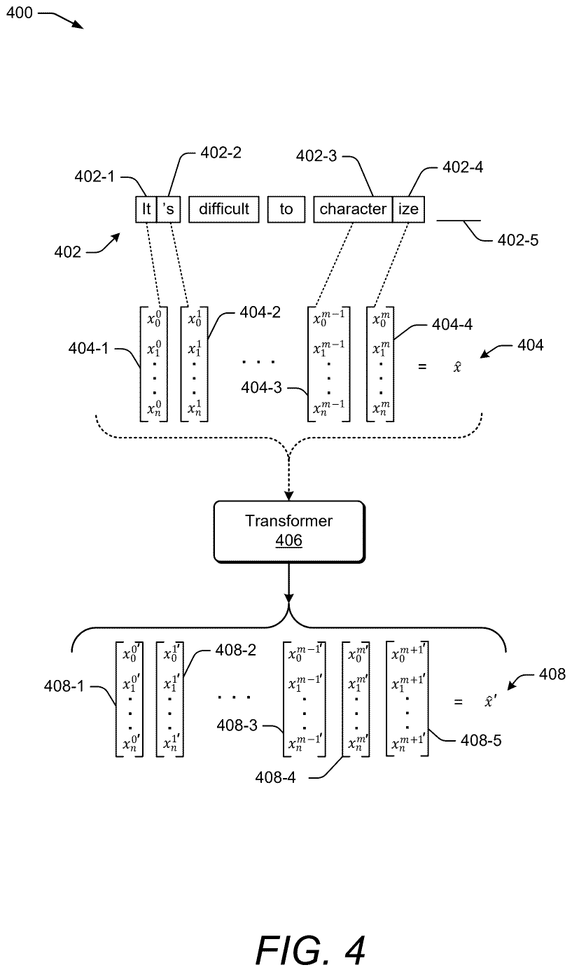

By way of example, consider FIG. 4, which illustrates a trainer 400 by which to train an LLM (e.g., the LLM 222 of FIG. 2) used for extracting structured intelligence from a free-form emergency input. The trainer 400 receives training data as training inputs (e.g., an input 402). This training data may be of many different types (e.g., labeled text and prediction data). In the context of an LLM augmented user emergency interface, the training dataset may include historical emergency communications. These historical emergency communications may include associations between unstructured distress messages and target structured communication formats utilized by emergency service providers. In the example illustrated by FIG. 4, the training input 402 is a phrase, though it may instead be a word, a long text passage (e.g., a book, article, or web-page), or any other data containing comprehensible text. In some examples, the text is from a screen or image capture. In a process called “tokenization,” the trainer 400 breaks the training input 402 into tokens, marked as tokens 402-1, 402-2, 402-3, and 402-4. Here, the training input 402 has a missing next word, marked as a blank 402-5. The goal of the trainer 400 is to predict the blank 402-5.

The trainer 400 encodes the tokens (402-1, 402-2, etc.) into an input tensor \hat{x} 404 through a mapping procedure. For instance, the token “It” 402-1 is mapped to a first component 404-1 of the input tensor \hat{x} 404, the token “'s” 402-2 is mapped to a second component 404-2 of the input tensor \hat{x} 404, the token “character” 402-3 is mapped to a third component 404-3 of the input tensor \hat{x} 404, and the token “ize” is mapped to a fourth component 404-4 of the input tensor \hat{x} 404. Though the tokens “It” 402-1 and “'s” 402-2 are shown as two portions of the word “It's,” other mapping schemes exist (e.g., mapping based on discrete words or phonemes). In some instances, an ML model or an ML component of the trainer 400 performs the tokenization and/or mapping of the training input 402 into the input tensor \hat{x} 404 (e.g., a feature-extracting convolutional neural network (CNN)). The mapping of the tokenized training input 402 into the input tensor \hat{x} 404 may involve a lookup table, which maps each possible token (e.g., 402-1, 402-2, etc.) to a known tensor object in a language space of the training data. The mapping of the tokens 402, in some examples, is referred to as an embedding.

A transformer 406 takes the input tensor \hat{x} 404 as an input, with the goal of predicting the blank 402-5 by transforming the input tensor \hat{x} 404 into a transformed tensor \hat{x}′ 408. The transformation process is mathematically represented as follows:

$$T \hat{x} = {\hat{x}}^{′} \qquad Eq . 1$$

T in Eq. 1 represents the transformer 406. The transformed tensor \hat{x}′ 408 includes components 408-1, 408-2, 408-3, 408-4, and 408-5. The component 408-1 is a transformation of the component 404-1 by the transformer 406 (similar for component pairs 408-2/404-2, 408-3/404-3, and 408-4/404-4). The component 408-5 corresponds to the blank 402-5, and thus the component 408-5 is a prediction for the blank 402-5. The final transformed tensor \hat{x}′ 408 component 408-5 is derived as part of the transformation process in addition to the contextualization of the components 404-1 through 404-4.

In some examples, the final transformed tensor \hat{x}′ 408 component 408-5 is multiple components. For example, a second transformed tensor \hat{x}″ (not pictured) can be generated by performing a different transformation T′ (not pictured) as follows:

$${T}^{′} \hat{x} = {\hat{x}}^{″} \qquad Eq . 2$$

A plurality of transformed tensors (e.g., the final transformed tensor \hat{x}′, the second transformed tensor \hat{x}″) may be generated. The plurality of transformed tensors, in some examples, can be compared by the LLM, and based on the comparison, one or more of the plurality of transformed tensors may be selected for output. In the context of the present disclosure, the plurality of transformed tensors may represent multiple candidate extractions of emergency details, from which the LLM can select the most accurate formatting and context representation for the final emergency message.

Inputs (e.g., the input tensor \hat{x} 404 and/or the training input 402) generally include multiple tokens. For instance, the training input 402 includes the tokens 402-1 through 402-4. The trainer 400 converts a single training input (e.g., the training input 402) into multiple training inputs. For example, by removing the token 402-4, the blank 402-5 “shifts left” as the training input 402 calls for the trainer 400 to predict the token 402-4, thus creating a new training input from the original training input 402. As the value for the token 402-4 is known in this example, the new input is a labeled input, which allows it to be used by a supervised ML training algorithm (it should be noted that such an input is also able to be used by an unsupervised ML training algorithm). In this way, a single text containing multiple tokens (e.g., a book, a research paper, etc.) is used as multiple training inputs for the trainer 400.

### Example Methods

The method 500 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to any of the preceding figures or processes as detailed in other figures, reference to which is made for example only. The techniques are not limited to performance by one entity or multiple entities operating on one device.

Generally, any of the components, modules, methods, and operations described herein can be implemented using software, firmware, hardware (e.g., fixed logic circuitry), manual processing, or any combination thereof. Some operations of the example methods may be described in the general context of computer program products (e.g., executable instructions stored on computer-readable storage memory that is local and/or remote to a computer processing system), and implementations can include software applications, programs, functions, and the like. Alternatively or in addition, any of the functionality described herein can be performed, at least in part, by one or more hardware logic components, for example, and without limitation, field-programmable gate arrays (FPGAs), application-specific integrated circuits (ASICs), application-specific standard products (ASSPs), system-on-a-chip systems (SoCs), complex programmable logic devices (CPLDs), and the like.

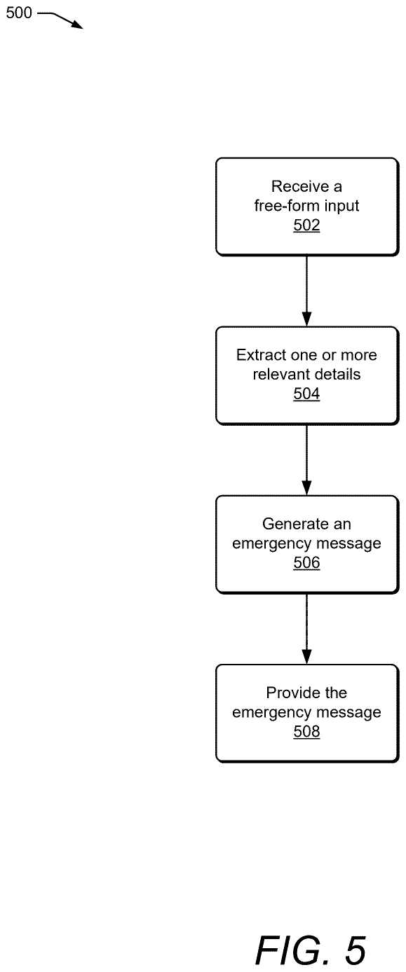

FIG. 5 illustrates an example method 500 for implementing a large language model augmented user emergency interface. At 502, a free-form input (e.g., the free-form input 104 of FIG. 1 or 302 of FIG. 3) is received. In aspects, the free-form input is associated with an emergency event. The free-form input may be received via an emergency interface. The user emergency interface may be instantiated within one or more of a dedicated application (e.g., a satellite messaging application) and a native operating system interface. In some examples, the native operating system interface includes a 911 communication interface. Furthermore, the user emergency interface may be instantiated on a wearable device, such as a smartwatch or one or more earbuds. The user emergency interface may include one or more of a text-based interface and an audio-based interface. In examples where the user emergency interface includes the audio-based interface, the audio-based interface can be configured to receive a voice recording or to receive a spoken input during an active voice call. The free-form input may include one or more of a text input, a voice input, and a natural language input. In some instances, the example method further includes initiating an emergency voice call over a terrestrial network, detecting a disconnection of the emergency voice call, and subsequently using the method to provide an emergency message as a backup textual transmission.

At 504, one or more relevant details of the emergency event are extracted. In aspects, the one or more relevant details are extracted with a large language model (e.g., the LLM 222 of FIG. 2), where the LLM may be a lightweight LLM configured to execute locally on a user device (e.g., the electronic device 102 of FIG. 1). The LLM may be instantiated on the user device, and the extracting of the one or more relevant details may be performed entirely on the user device to prevent transmission delays. In some examples, the one or more relevant details include one or more of a location associated with the emergency event, an injury status, a psychological state, an equipment loss, a number of individuals associated with the emergency event, and a resource requirement. The location associated with the emergency event may be based at least in part on one or more device parameters of the user device. In further examples, the device parameters include one or more of a GPS output, a cellular network connection status of the user device, and a Wi-Fi connection status of the user device. The GPS output may be generated by one or more GPS sensors (e.g., the sensor modules 212 of FIG. 2) of the user device. Additionally, the location associated with the emergency event may be based at least in part on a known access point location associated with the Wi-Fi connection status. In some instances, the location associated with the emergency event includes a first location extracted from the free-form input and a second location derived from the one or more device parameters. The extracting of the one or more relevant details may include applying a fixed prompt to the LLM, where the fixed prompt is configured to guide identification of the one or more relevant details. The extracting may further include formatting the free-form input according to a predefined prompt template that may include one or more structural constraints and few-shot examples mapping sample free-form inputs to standardized emergency outputs. The extracting may also be augmented by querying a knowledge base to retrieve contextual reference data based on the free-form input prior to the extraction of the details.

At 506, an emergency message (e.g., the emergency message 106 of FIG. 1 or 304 of FIG. 3) is generated. The emergency message may be generated by the LLM and may be based on the one or more relevant details. In some examples, the generating of the emergency message is performed locally on the user device. The generating of the emergency message may include formatting the one or more relevant details into a standardized syntax, such as an all-caps format, to ensure high fidelity and minimal data overhead. In examples where multiple location sources are used, the generating of the emergency message can include combining the first location extracted from the text with the second location derived from the device parameters. Furthermore, the LLM may generate a dynamic questionnaire (e.g., the dynamic questionnaire 306 of FIG. 3) tailored to the situation of the emergency event. After providing the dynamic questionnaire via the user emergency interface and receiving a response (e.g., via at least one click-based selection 308 of FIG. 3), the LLM extracts one or more additional relevant details from the response. The generation of the emergency message can then be further based on these additional relevant details by consolidating them into a single transmission payload.

At 508, the emergency message is provided. The emergency message may be provided for an emergency messaging session. The example method may further include determining whether the emergency messaging session utilizes a bandwidth-constrained network or a latency-constrained network, such as a satellite communication network. Based at least in part on determining that the emergency messaging session utilizes the bandwidth-constrained network or the latency-constrained network, the electronic device can compress the emergency message prior to the providing of the emergency message. Compressing the emergency message may include converting the one or more relevant details into one or more binary encodings. These binary encodings can correspond to one or more predefined identifiers recognizable by an emergency rescue center. Additionally, the provided emergency message may serve as a backup textual transmission in response to the detection of a disconnected emergency voice call over a terrestrial network.

Throughout this disclosure, examples are described where a computing system (e.g., the electronic device 102 of FIG. 1) may analyze information (e.g., the free-form input 104 of FIG. 1 or 302 of FIG. 3) associated with a user; for example, the free-form input 104 can be text from a messaging application (e.g., from an instantiated emergency services or satellite SOS application). In a non-limiting example, a complete solution may include an electronic device configured to receive a free-form input, extract one or more relevant details using a local large language model, and generate an emergency message for transmission over a bandwidth-constrained or latency-constrained network. Further to the descriptions above, the user may be provided with controls allowing the user to make an election as to both if and when systems, programs, and/or features described herein may enable collection of information (e.g., information about a user's location, injury status, psychological state, biometric data, or other sensitive details), and if the user is sent content or communications from a server. The computing system can be configured to only use the information after the computing system receives explicit permission from the user of the computing system to use the data. For example, in situations where an application of the computing system contains private emergency or health-related data used as the information, the user may be provided with an opportunity to provide input to control whether programs or features of the computing system can collect and make use of the information. Further, individual users may have constant control over what programs can or cannot do with the information. In addition, information collected may be pre-treated in one or more ways before it is transferred, stored, or otherwise used, so that a user's identity is removed where appropriate, while preserving critical triage data. Furthermore, any collected information may be processed locally on the electronic device 102 to the maximum extent feasible, and any transmitted information may be heavily encrypted to ensure data security and privacy during transmission over a network. Thus, the user may have control over whether information is collected about the user and a device of the user and how such information, if collected, may be used by the computing system and/or a remote computing system.

### CONCLUSION

As used herein, a phrase referring to “at least one of” or “one or more of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Although concepts of a large language model augmented user emergency interface have been described in language specific to techniques and/or systems, it is to be understood that the subject of the appended claims is not necessarily limited to the specific techniques or methods described. Rather, the specific techniques and methods are disclosed as example implementations for a large language model augmented user emergency interface.

What is claimed is:

1. A method comprising:
receiving, by one or more processors via a user emergency interface on a user device, a free-form input associated with an emergency event;
extracting, with a large language model (LLM), one or more relevant details of the emergency event from the free-form input;
generating, by the LLM, an emergency message based on the one or more relevant details; and
providing, for an emergency messaging session, the emergency message.

2. The method of claim 1, wherein:
the LLM is a lightweight LLM configured to execute locally on a user device;
the LLM is instantiated on the user device;
the extracting of the one or more relevant details is performed on the user device; and
the generating of the emergency message is performed on the user device.

3. The method of claim 1, wherein the free-form input comprises a text input or a voice input.

4. The method of claim 1, wherein the free-form input comprises a natural language input.

5. The method of claim 1, wherein the one or more relevant details comprise a location associated with the emergency event, an injury status, a psychological state, an equipment loss, a number of individuals associated with the emergency event, or a resource requirement.

6. The method of claim 1, wherein:
the one or more relevant details comprise a location associated with the emergency event; and
the location associated with the emergency event is determined using one or more device parameters of a user device.

7. The method of claim 6, wherein the one or more device parameters comprise one or more of a Global Positioning System (GPS) output, a cellular network connection status of the user device, and a Wi-Fi connection status of the user device.

8. The method of claim 7, wherein:
the one or more device parameters comprise the GPS output; and
the GPS output is generated by one or more GPS sensors of the user device.

9. The method of claim 1, wherein the generating of the emergency message comprises formatting the one or more relevant details into an all-caps format using a standardized syntax.

10. The method of claim 1, wherein the emergency messaging session utilizes a satellite communication network.

11. The method of claim 10, further comprising:
compressing the emergency message prior to the providing of the emergency message over the satellite communication network, wherein the compressing of the emergency message comprises converting the one or more relevant details into one or more binary encodings corresponding to one or more predefined identifiers recognizable by an emergency rescue center.

12. The method of claim 1, further comprising:
generating, by the LLM, a dynamic questionnaire tailored to a specific situation of the emergency event;
providing the dynamic questionnaire via the user emergency interface;
receiving a response to the dynamic questionnaire; and
extracting one or more additional relevant details from the response;
wherein the generating of the emergency message is further based on the one or more additional relevant details.

13. The method of claim 1, wherein:
the emergency message has a reduced footprint from the free-form input; and
the footprint comprises a measure of used compute resources.

14. The method of claim 13, wherein the compute resources comprise one or more of a memory usage, a processor cycle usage, and a network usage.
